(19) United States
(12) Patent Application Publication
(10) Pub. No.: US 2025/0271691 A1
(43) Pub. Date: Aug. 28, 2025

(54) WAVELENGTH CONVERSION MODULE, BACKLIGHT MODULE, AND MANUFACTURING METHOD OF WAVELENGTH CONVERSION MODULE

(71) Applicant: Coretronic Corporation, Hsin-Chu (TW)

(72) Inventors: YEN-NI LIN, Hsin-Chu (TW); CHING-NAN CHUANG, Hsin-Chu (TW); HUNG-TSE LIN, Hsin-Chu (TW); MING-DAH LIU, Hsin-Chu (TW)

(21) Appl. No.: 19/063,359

(22) Filed: Feb. 26, 2025

(30) Foreign Application Priority Data
Feb. 27, 2024 (CN) 202410212208.3

(51) Int. Cl. G02F 1/017; F21V 8/00; G02F 1/01; G02F 1/25

(52) U.S. Cl. CPC G02F 1/01791; G02B 6/005; G02F 1/0105; G02F 1/0107; G02F 1/25; G02F 2202/046; G02F 2202/106; G02F 2202/107; G02F 2203/03

(57) ABSTRACT

A wavelength conversion module includes a substrate, a barrier wall structural layer, a plurality of wavelength conversion layers and a plurality of quantum dot particles. The substrate has a surface. The barrier wall structural layer is disposed on the surface and defines a plurality of recesses. Each of the wavelength conversion layers is located in one of the recesses. The quantum dot particles are disposed in the wavelength conversion layers. A backlight module having the wavelength conversion module and a manufacturing method of the wavelength conversion module are also provided.

### CROSS-REFERENCE TO RELATED APPLICATION

This application claims the priority benefit of China application serial no. 202410212208.3, filed on Feb. 27, 2024. The entirety of the above-mentioned patent application is hereby incorporated by reference herein and made a part of this specification.

### TECHNICAL FIELD

The disclosure relates to an optical module and a manufacturing method for the optical module, and more particularly to a wavelength conversion module, a backlight module having the wavelength conversion module, and a manufacturing method for the wavelength conversion module.

### BACKGROUND

In conventional technologies, most display devices are equipped with display panels and backlight modules. Some of the backlight modules are provided with quantum dot films. In detail, quantum dots have the advantages of narrow full width at half maximum (FWHM), high light emission efficiency, a wide optical absorption spectrum, and the like. Therefore, the backlight module provided with the quantum dot film can effectively enhance the color brightness and the color saturation of the backlight source.

However, conventional quantum dots are usually made of toxic heavy metals, resulting in a limited quantity of quantum dots provided for the quantum dot films. Therefore, conventional quantum dot films usually have a problem with poor wavelength conversion efficiency, which affects the light color quality of the backlight module. In addition, after the thickness of the conventional quantum dot film is reduced, a problem of insufficient stiffness is likely to occur, so that the quantum dot film cannot be effectively thinned.

The information disclosed in this “BACKGROUND” section is only for enhancement understanding of the background and therefore it may contain information that does not form the prior art that is already known to a person of ordinary skill in the art. Furthermore, the information disclosed in this “BACKGROUND” section does not mean that one or more problems to be solved by one or more embodiments of the disclosure were acknowledged by a person of ordinary skill in the art.

### SUMMARY

A wavelength conversion module in one embodiment of the disclosure includes a substrate, a barrier wall structural layer, a plurality of wavelength conversion layers, and a plurality of quantum dot particles. The substrate has a surface. The barrier wall structural layer is disposed on the surface and defines a plurality of recesses. Each of the wavelength conversion layers is located in one of the recesses. The quantum dot particles are disposed in the wavelength conversion layers.

A backlight module in one embodiment of the disclosure includes a light source and a wavelength conversion module. The light source is configured to generate an excitation beam. The wavelength conversion module is disposed on a transmission path of the excitation beam.

A manufacturing method for a wavelength conversion module in one embodiment of the disclosure includes the following steps: disposing a first curable adhesive on a substrate, and curing the first curable adhesive to form a barrier wall structural layer, where the barrier wall structural layer defines a plurality of recesses; and mixing a plurality of quantum dot particles in a plurality of second curable adhesives, filling each of the second curable adhesives in a corresponding one of the recesses, disposing a cover plate on one side that is of the barrier wall structural layer and that is away from the substrate; and then curing the second curable adhesives to form a plurality of wavelength conversion layers.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic cross-sectional view of a wavelength conversion module according to an embodiment of the disclosure;

FIG. 2 is a schematic top view of the wavelength conversion module in FIG. 1;

FIG. 3 is a schematic cross-sectional view of a wavelength conversion module according to another embodiment of the disclosure;

FIG. 4 is a schematic cross-sectional view of a wavelength conversion module according to another embodiment of the disclosure;

FIG. 5 is a schematic cross-sectional view of a wavelength conversion module according to another embodiment of the disclosure;

FIG. 6 is a schematic cross-sectional view of a wavelength conversion module according to another embodiment of the disclosure;

FIG. 7 is a schematic cross-sectional view of a backlight module according to an embodiment of the disclosure;

FIG. 8 is a schematic cross-sectional view illustrating a step of a manufacturing method for the wavelength conversion module according to an embodiment of the disclosure;

FIG. 9 is a schematic cross-sectional view illustrating the step, following the step in FIG. 8, of a manufacturing method for the wavelength conversion module;

FIG. 10 is a schematic cross-sectional view illustrating the step, following the step in FIG. 9, of a manufacturing method for the wavelength conversion module;

FIG. 11 is a schematic cross-sectional view illustrating a step of a manufacturing method for a wavelength conversion module according to another embodiment of the disclosure;

FIG. 12 is a schematic cross-sectional view illustrating a step of a manufacturing method for a wavelength conversion module according to another embodiment of the disclosure;

FIG. 13 is a schematic cross-sectional view illustrating a step of a manufacturing method for a wavelength conversion module according to another embodiment of the disclosure;

FIG. 14 is a schematic cross-sectional view illustrating a step of a manufacturing method for the wavelength conversion module according to another embodiment of the disclosure;

FIG. 15 is a schematic cross-sectional view illustrating the step, following the step in FIG. 14, of a manufacturing method for the wavelength conversion module; and

FIG. 16 is a schematic cross-sectional view illustrating a step of a manufacturing method for a wavelength conversion module according to another embodiment of the disclosure.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the disclosure may be practiced. In this regard, directional terminology, such as “top”, “bottom”, “front”, “back”, etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

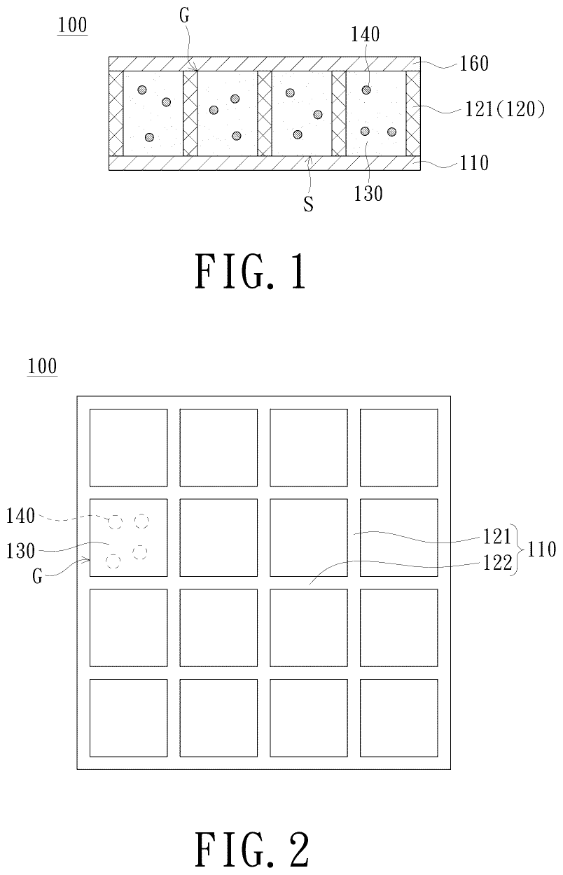

FIG. 1 is a schematic cross-sectional view of a wavelength conversion module according to an embodiment of the disclosure. FIG. 2 is a schematic top view of the wavelength conversion module in FIG. 1. Refer to FIG. 1 first. The wavelength conversion module 100 includes a substrate 110, a barrier wall structural layer 120, a plurality of wavelength conversion layers 130, and a plurality of quantum dot particles 140. The substrate 110 has a surface S. The barrier wall structural layer 120 is disposed on the surface S and defines a plurality of recesses G. Each wavelength conversion layer 130 is correspondingly disposed in one of the recesses G. The quantum dot particles 140 are disposed in the wavelength conversion layers 130 (e.g., the quantum dot particles 140 may be mixed into the wavelength conversion layers 130).

The substrate 110 is configured to allow a beam to pass therethrough and be incident into the wavelength conversion layer 130. For example, the material of the substrate 110 may include polyethylene terephthalate (PET), but the disclosure is not limited thereto. In this embodiment, the material of the quantum dot particles 140 may include cadmium selenide (CdSe) or cadmium sulfide (CdS), where cadmium is a toxic heavy metal. In one embodiment, the material of the quantum dot particles 140 may include zinc selenide (ZnSe). Incidentally, the quantum dot particles 140 in this embodiment may include nano-scale phosphors, but the disclosure is not limited thereto.

In this embodiment, the wavelength conversion layers 130 may further include wavelength conversion particles different from the quantum dot particles 140, or a material of the wavelength conversion layers 130 may be a material with a wavelength conversion function. The wavelength conversion layers 130 may be used to provide a function of converting the wavelength of an incident beam. For example, the wavelength conversion layer 130 includes, for example, cured curable resin, and the wavelength conversion particles may be mixed into the cured curable resin. Further, the curable resin may include an ultraviolet curable resin; however, other embodiments are not limited thereto. For example, in one embodiment, the material of the wavelength conversion layer 130 may include a hydrophobic material, and the quantum dot particles 140 may be disposed in the hydrophobic material. The hydrophobic material includes, for example, epoxy silicon, silicone, or acrylic material. In another embodiment, the material of the wavelength conversion layer 130 may include a non-hydrophobic material, and the quantum dot particles 140 may be disposed in the non-hydrophobic material.

In this embodiment, the material of the barrier wall structural layer 120 includes, for example, a cured curable resin. The curable resin may include an ultraviolet curable resin, but the disclosure is not limited thereto. The barrier wall structural layer 120 in this embodiment may include a plurality of barrier wall structures 121 and barrier wall structures 122, and the barrier wall structures 121 and the barrier wall structures 122 can define the plurality of recesses G. In addition, the plurality of barrier wall structures 121 and barrier wall structures 122 can be an integrally-formed structure. Refer to FIG. 1 and FIG. 2 together. The barrier wall structure 121 and the barrier wall structure 122 can be disposed on the surface S, and the barrier wall structure 121 may be non-parallel to the barrier wall structure 122, so the barrier wall structural layer 120 is in a grid pattern. Specifically, a recess G can be defined between two adjacent barrier wall structures 121 and two adjacent barrier wall structures 122. However, in an embodiment, the barrier wall structural layer 120 may not be provided with the barrier wall structure 122, and a recess G can be defined between two adjacent barrier wall structures 121. Still refer to FIG. 1. In this embodiment, the shape of each barrier wall structure 121 and each barrier wall structure 122 may be a rectangular column. However, in other embodiments, the shape of each barrier wall structure 121 and each barrier wall structure 122 may be a trapezoidal column or a triangular column, and the disclosure is not limited thereto. It is to be noted that the quantum dot particles 140 emit light in a manner of non-directional, and the wavelength conversion layer 130 can also emit light in a manner of non-directional. In this embodiment, the barrier wall structural layer 120 can reduce the angle at which the beam is emitted from the wavelength conversion layer 130. In this way, the beams emitted by the quantum dot particles 140 and the wavelength conversion layer 130 can be emitted from the recess G in a more concentrated manner, thereby increasing the amount of forward light emitted by the wavelength conversion module 100.

Incidentally, the wavelength conversion module 100 in this embodiment may further include a cover plate 160, and the wavelength conversion layers 130 are disposed between the substrate 110 and the cover plate 160 to further protect the wavelength conversion layers 130. The feature of the cover plate 160 is approximately the same as the feature of the substrate 110, and no redundant detail is to be given herein.

Compared with the conventional technologies, the wavelength conversion module 100, the backlight module (will be described below), and the manufacturing method for the wavelength conversion module 100 (will be described below) in the embodiments have at least one of the following advantages. In the wavelength conversion module 100 in this embodiment, the wavelength conversion layers 130 and the quantum dot particles 140 can both convert the wavelength of the incident beam. The wavelength conversion layers 130 are not made of a toxic heavy metal. Therefore, the wavelength conversion module 100 in this embodiment can improve the wavelength conversion efficiency in the case that the quantity of the quantum dot particles 140 is limited. In addition, the wavelength conversion module 100 in this embodiment uses the barrier wall structural layer 120 to improve the stiffness, so the thickness of the wavelength conversion module 100 can be effectively reduced. For example, in an embodiment, the total thickness of the wavelength conversion module 100 may be approximately between 85 um and 100 um, wherein the thickness of the wavelength conversion layer 130 may be approximately between 10 um and 50 um, and the thickness of the substrate 110 or the cover plate 160 may be approximately between 12 um and 50 um.

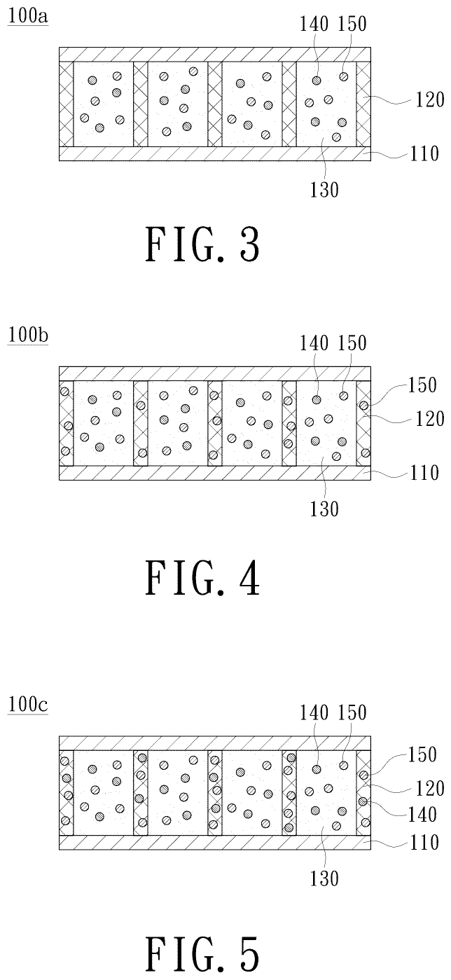

FIG. 3 is a schematic cross-sectional view of a wavelength conversion module according to another embodiment of the disclosure. The structure and advantages of the wavelength conversion module 100a in this embodiment are similar to the structure and advantages of the wavelength conversion module 100 in FIG. 1, and only the differences will be described below. Refer to FIG. 3. The wavelength conversion module 100a may further include a plurality of fluorescent particles 150, and the fluorescent particles 150 are disposed in the wavelength conversion layers 130. In detail, the wavelength conversion module 100a can emit beams with more saturated colors by using the fluorescent particles 150 with a light-emitting wavelength different from the light-emitting wavelength of the quantum dot particles 140. In addition, because the cost of the fluorescent particles 150 is lower than the cost of the quantum dot particles 140, the cost of the wavelength conversion module 100a can be effectively reduced. The material of the wavelength conversion layer 130 includes, for example, a cured curable resin, and the fluorescent particles 150 may be mixed into the cured curable resin. In this embodiment, the fluorescent particles 150 may include micron-scale phosphors, but the disclosure is not limited thereto.

It is to be noted that in one embodiment, the material of the quantum dot particles 140 is cadmium selenide (CdSe) and may include green quantum dot particles. Further, the fluorescent particles 150 include green fluorescent particles, and the weight percentage concentration of the green fluorescent particles in the wavelength conversion layer 130 is approximately between 3% and 4%. Therefore, the weight percentage concentration of the green quantum dot particles in the wavelength conversion layer 130 can be reduced by approximately between 0.3% and 0.4%, and the concentration of cadmium can be reduced by 20 ppm to 30 ppm, compared with the conventional technologies. Similarly, in another embodiment, the fluorescent particles 150 may include green fluorescent particles and red fluorescent particles. The weight percentage concentration of the green fluorescent particles in the wavelength conversion layer 130 is the same as that described above, and the weight percentage concentration of the red fluorescent particles in the wavelength conversion layer 130 is approximately 4%. Based on this, the weight percentage concentration of the red quantum dot particles in the wavelength conversion layer 130 can be reduced by approximately between 0.01% and 0.03%, and the concentration of cadmium can be reduced by 50 ppm to 80 ppm, compared with the concentration in conventional technologies.

FIG. 4 is a schematic cross-sectional view of a wavelength conversion module according to another embodiment of the disclosure. The structure and advantages of the wavelength conversion module 100b in this embodiment are similar to the structure and advantages of the wavelength conversion module 100a in FIG. 3, and only the differences will be described below. Refer to FIG. 4. The fluorescent particles 150 may be further disposed in the barrier wall structural layer 120. In other words, the fluorescent particles 150 may be distributed in the wavelength conversion layer 130 and the barrier wall structural layer 120. In this way, the quantity of the fluorescent particles 150 can be increased, and the wavelength conversion rate of the wavelength conversion module 100b can be further increased. In addition, because the quantity of the fluorescent particles 150 is increased, the quantity of the quantum dot particles 140 can be further reduced to further reduce the cost of the wavelength conversion module 100b. It can be understood that the wavelength conversion layer 130 in FIG. 4 is mixed with the fluorescent particles 150 to provide a wavelength conversion function; however, in other embodiments, the wavelength conversion layer 130 may not be mixed with the fluorescent particles 150 but provides the wavelength conversion function by other technical means.

FIG. 5 is a schematic cross-sectional view of a wavelength conversion module according to another embodiment of the disclosure. The structure and advantages of the wavelength conversion module 100c in this embodiment are similar to the structure and advantages of the wavelength conversion module 100b in FIG. 4, and only the differences will be described below. Refer to FIG. 5. The quantum dot particles 140 are, for example, further disposed in the barrier wall structural layer 120. In other words, the quantum dot particles 140 are distributed in the wavelength conversion layer 130 and the barrier wall structural layer 120. Therefore, the quantity of the quantum dot particles 140 can be further increased to increase the wavelength conversion rate of the wavelength conversion module 100c. Similarly, in other embodiments, the wavelength conversion layer 130 may not be mixed with the fluorescent particles 150 but provides the wavelength conversion function by other technical means.

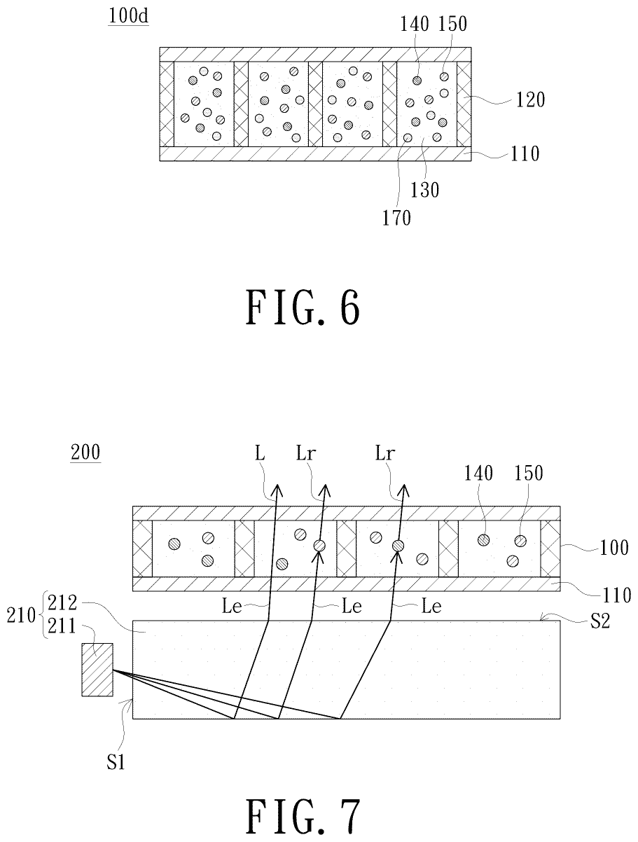

FIG. 6 is a schematic cross-sectional view of a wavelength conversion module according to another embodiment of the disclosure. The structure and advantages of the wavelength conversion module 100d in this embodiment are similar to the structure and advantages of the wavelength conversion module 100a in FIG. 3, and only the differences will be described below. Refer to FIG. 6. The wavelength conversion module 100d further includes, for example, a plurality of light-scattering particles 170. The light-scattering particles 170 are disposed in the barrier wall structural layer 120 and/or the wavelength conversion layer 130, and the light-scattering particles 170 in this embodiment are disposed in the wavelength conversion layer 130 as an example. In this way, the light utilization rate can be further increased, thereby further improving the wavelength conversion rate of the wavelength conversion module 100d. In this embodiment, the material of the light-scattering particles 170 may include titanium dioxide (TiO₂). However, in other embodiments, the material of the light-scattering particles 170 may include zirconia (ZrO₂), alumina (Al₂O₃), or silicon oxide (SiO₂), but the disclosure is not limited thereto. Incidentally, in one embodiment, the light-scattering particles 170 may be disposed in the barrier wall structural layer 120 but not disposed in the wavelength conversion layer 130. In another embodiment, the light-scattering particles 170 may be disposed in both the barrier wall structural layer 120 and the wavelength conversion layer 130. Similarly, in other embodiments, the wavelength conversion layer 130 may not be mixed with the fluorescent particles 150 but provide the wavelength conversion function by other technical means.

FIG. 7 is a schematic cross-sectional view of a backlight module according to an embodiment of the disclosure. Refer to FIG. 7. The backlight module 200 includes a light source 210 and a wavelength conversion module 100a. The light source 210 is configured to generate an excitation beam Le. The wavelength conversion module 100a is disposed on a transmission path of the excitation beam Le. It should be noted that the backlight module 200 in this embodiment is, for example, an edge-type backlight module, but the disclosure is not limited thereto.

In this embodiment, the light source 210 may include a light-emitting assembly 211 and a light guide plate 212. The light-emitting assembly 211 is disposed opposite to the light-incident surface S1 of the light guide plate 212. Specifically, the light-emitting assembly 211 can generate the excitation beam Le, and the light guide plate 212 can guide the excitation beam Le to emit from the light-emitting surface S2. The light-emitting assembly 211 includes, for example, a light-emitting diode, which is not limited to other embodiments. In addition, the light-emitting assembly 211 in this embodiment can generate a blue excitation beam Le, but the disclosure is not limited thereto.

In this embodiment, the wavelength conversion module 100a is, for example, disposed opposite to the light-emitting surface S2 of the light guide plate 212 to receive the excitation beam Le emitted from the light-emitting surface S2. In detail, the light-emitting surface S2 of the light guide plate 212 can face the substrate 110 of the wavelength conversion module 100a. The wavelength conversion module 100a can absorb at least a part of the excitation beams Le and generate the conversion beams Lr with a wavelength different from the wavelength of the excitation beams Le. For example, the light source 210 can generate blue excitation beams Le, and the wavelength conversion module 100a can convert the blue excitation beams Le into green and red conversion beams Lr. Further, the green conversion beams Lr can be emitted by the green quantum dot particles 140 and the green fluorescent particles 150, while the red conversion beams Lr can be emitted by the red quantum dot particles 140 and the red fluorescent particles 150. In addition, the wavelength of the other excitation beams Le is not converted by the quantum dot particles 140 or the fluorescent particles 150 but the other excitation beams Le pass through the wavelength conversion module 100a to form the beams L, wherein the beams L and the conversion beams Lr can together form color light.

Compared with the conventional technologies, the wavelength conversion module 100a is used for the backlight module 200 in this embodiment so the thickness can be reduced. In addition, the backlight module 200 can further improve the color quality even when the quantity of the quantum dot particles 140 is limited. In other embodiments, the wavelength conversion module 100, 100b, 100c, or 100d may be used for the backlight module 200.

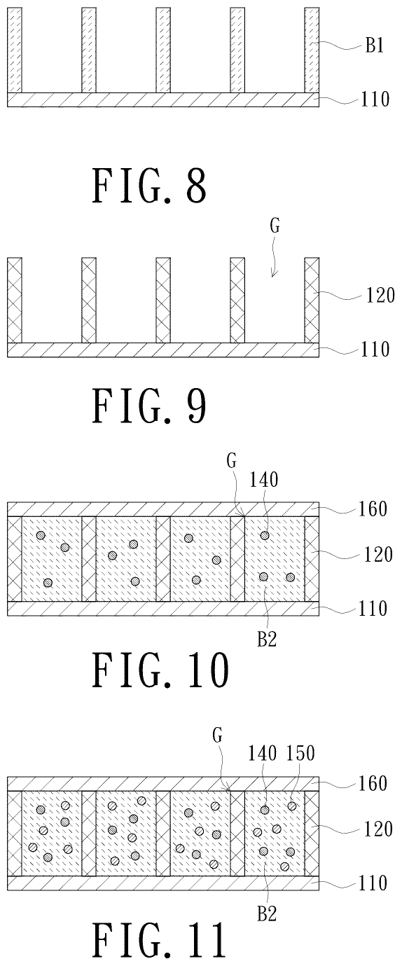

FIG. 8 is a schematic cross-sectional view illustrating a step of a manufacturing method for the wavelength conversion module according to an embodiment of the disclosure. FIG. 9 is a schematic cross-sectional view illustrating the step, following the step in FIG. 8, of a manufacturing method for the wavelength conversion module. FIG. 10 is a schematic cross-sectional view illustrating the step, following the step in FIG. 9, of a manufacturing method for the wavelength conversion module. The manufacturing method for the wavelength conversion module 100 includes the following steps. First, refer to FIG. 8 and FIG. 9. A first curable adhesive B1 is disposed on a substrate 110, and the first curable adhesive B1 is cured to form a barrier wall structural layer 120, wherein the barrier wall structural layer 120 defines a plurality of recesses G. For example, the first curable adhesive B1 may be disposed on the substrate 110 in a grid pattern, and forms the barrier wall structural layer 120 shown in FIG. 2 after cured. Still refer to FIG. 8 and FIG. 9. In this embodiment, the first curable adhesive B1 may include a light-curable adhesive, and the first curable adhesive B1 may form the barrier wall structural layer 120 through light curing. Refer to FIG. 10, after the barrier wall structural layer 120 is formed on the substrate 110, a plurality of quantum dot particles 140 are mixed into a plurality of second curable adhesives B2, each of the mixed second curable adhesives B2 is correspondingly filled in one of the recesses G, and a cover plate 160 is disposed on one side of the barrier wall structural layer 120 facing away from the substrate 110. Next, the second curable adhesive B2 is cured to form the wavelength conversion layer 130 shown in FIG. 1, thereby forming the wavelength conversion module 100 shown in FIG. 1.

Refer to FIG. 1 and FIG. 9 together. In this embodiment, the second curable adhesive B2 may include a light-curable adhesive, and the second curable adhesive B2 may form the wavelength conversion layer 130 through light curing. Further, the quantum dot particles 140 are mixed into the second curable adhesives B2 before the second curable adhesives B2 are cured, and the second curable adhesives B2 mixed with the quantum dot particles 140 are filled in the recesses G. In this way, the quantum dot particles 140 may be fixed in the wavelength conversion layer 130 after the second curable adhesives B2 are cured to form the wavelength conversion layer 130. In addition, the wavelength conversion layer 130 may have a function of converting the wavelength of the incident light. For example, in an embodiment, the material with the wavelength conversion function may be used for or added to the wavelength conversion layer 130. Incidentally, in this embodiment, the cover plate 160 is disposed on the second curable adhesives B2 and the barrier wall structural layer 120 before the second curable adhesives B2 are cured and is fixed to the wavelength conversion layer 130 and the barrier wall structural layer 120 after the second curable adhesives B2 are cured into the wavelength conversion layer 130.

Compared with the conventional technologies, in the manufacturing method for the wavelength conversion module 100 in this embodiment, the barrier wall structural layer 120 is formed by curing the first curable adhesive B1 on the substrate 110, and then the second curable adhesives B2 are disposed in the recesses G in the barrier wall structural layer 120. Further, the quantum dot particles 140 are mixed into the second curable adhesives B2, and the wavelength conversion layers 130 can be formed by curing the second curable adhesives B2. The barrier wall structural layer 120 can increase the stiffness of the wavelength conversion layer 130 after the thickness of the wavelength conversion layer 130 is reduced, and the wavelength conversion layer 130 and the quantum dot particles 140 can both provide a wavelength conversion function; thus, the wavelength conversion module 100 with a good wavelength conversion efficiency, a low cost, and a small thickness can be provided in the manufacturing method in this embodiment.

FIG. 11 is a schematic cross-sectional view illustrating a step of a manufacturing method for a wavelength conversion module according to another embodiment of the disclosure. The manufacturing method in this embodiment is similar to the manufacturing method in FIG. 10, and only the difference will be described below. Before the step of filling the second curable adhesives B2 in the recesses G shown in FIG. 10, the manufacturing method in this embodiment includes the following steps. Refer to FIG. 11. A plurality of fluorescent particles 150 are added to the second curable adhesives B2 so the second curable adhesives B2 mixed with the fluorescent particles 150 are successively disposed in the recesses G. In other words, the second curable adhesives B2 are mixed with the fluorescent particles 150 and the quantum dot particles 140. Refer to FIG. 3 and FIG. 11 together. In this way, the second curable adhesives B2 mixed with the fluorescent particles 150 and the quantum dot particles 140 are filled in the recesses G, and the fluorescent particles 150 and the quantum dot particles 140 are fixed in the wavelength conversion layer 130 after the second curable adhesives B2 are cured to form the wavelength conversion layer 130, as shown in FIG. 3.

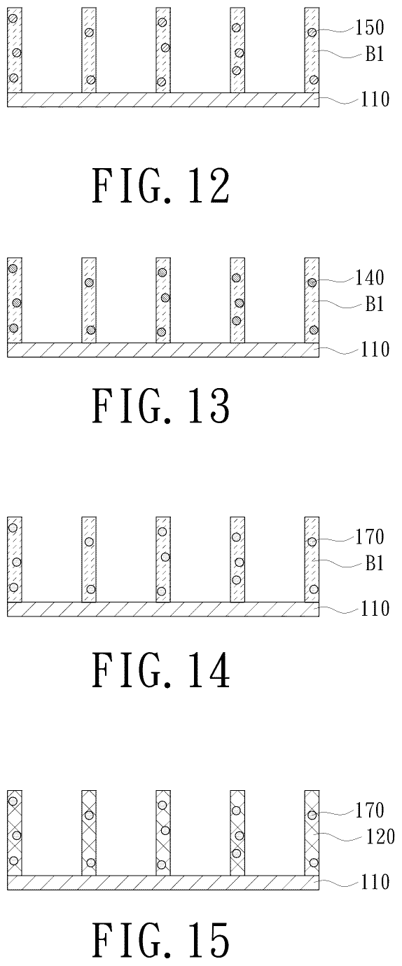

FIG. 12 is a schematic cross-sectional view illustrating a step of a manufacturing method for a wavelength conversion module according to another embodiment of the disclosure. The manufacturing method in this embodiment is similar to the manufacturing method in FIG. 10 or FIG. 11, and only the difference will be described below. Before the step of disposing the first curable adhesive B1 on the substrate 110 in FIG. 10, the manufacturing method in this embodiment includes the following steps. Refer to FIG. 12. A plurality of fluorescent particles 150 are added to the first curable adhesive B1 so the first curable adhesive B1 mixed with fluorescent particles 150 is successively disposed in the substrate 110. Refer to FIG. 4 and FIG. 12 together. In this way, the fluorescent particles 150 may be fixed in the barrier wall structural layer 120 after the first curable adhesive B1 is cured to form the barrier wall structural layer 120. It can be understood that the second curable adhesives B2 may not be mixed with the fluorescent particles 150 but be cured to form the wavelength conversion layer 130 in other embodiments. In this case, the fluorescent particles 150 are not disposed in the wavelength conversion layer 130, and the wavelength conversion layer 130 can provide the wavelength conversion function by other technical means.

FIG. 13 is a schematic cross-sectional view illustrating a step of a manufacturing method for a wavelength conversion module according to another embodiment of the disclosure. The manufacturing method in this embodiment is similar to the manufacturing method in FIG. 8, and only the difference will be described below. Before the step of disposing the first curable adhesive B1 on the substrate 110 in FIG. 8, the manufacturing method in this embodiment includes the following steps. Refer to FIG. 13. The quantum dot particles 140 are added to the first curable adhesive B1 so that the first curable adhesive B1 mixed with quantum dot particles 140 is successively disposed in the substrate 110. Refer to FIG. 5 and FIG. 13 together. In this way, the quantum dot particles 140 may be fixed in the barrier wall structural layer 120 after the first curable adhesive B1 is cured to form the barrier wall structural layer 120. Incidentally, in an embodiment, the first curable adhesive B1 may be mixed with the quantum dot particles 140 and the fluorescent particles 150, and the quantum dot particles 140 and the fluorescent particles 150 are fixed in the barrier wall structural layer 120 after the first curable adhesive B1 is cured to form the barrier wall structural layer 120, as shown in FIG. 5.

FIG. 14 is a schematic cross-sectional view illustrating a step of a manufacturing method for the wavelength conversion module according to another embodiment of the disclosure. FIG. 15 is a schematic cross-sectional view illustrating the step, following the step in FIG. 14, of a manufacturing method for the wavelength conversion module. The manufacturing method in this embodiment is similar to the manufacturing method in FIG. 8, and only the difference will be described below. Before the step of disposing the first curable adhesive B1 on the substrate 110 in FIG. 8, the manufacturing method in this embodiment includes the following steps. Refer to FIG. 14. A plurality of light-scattering particles 170 are added to the first curable adhesive B1 so the first curable adhesive B1 mixed with the light-scattering particles 170 is successively disposed in the substrate 110. Refer to FIG. 14 and FIG. 15 together. Based on the above, the light-scattering particles 170 may be fixed in the barrier wall structural layer 120 after the first curable adhesive B1 is cured to form the barrier wall structural layer 120. It can be understood that, in other embodiments, the first curable adhesive B1 that has been mixed with the light-scattering particles 170 may also be mixed with the quantum dot particles 140 and/or the fluorescent particles 150 (all drawn in FIG. 11), and the disclosure is not limited thereto.

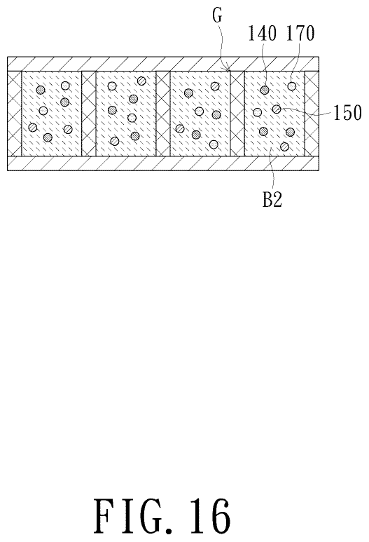

FIG. 16 is a schematic cross-sectional view illustrating a step of a manufacturing method for a wavelength conversion module according to another embodiment of the disclosure. The manufacturing method in this embodiment is similar to the manufacturing method in FIG. 10, and only the difference will be described below. Before the step of filling the second curable adhesives B2 in the recesses shown in FIG. 10, the manufacturing method in this embodiment includes the following steps. Refer to FIG. 16. A plurality of light-scattering particles 170 are added to the second curable adhesives B2 so the second curable adhesives B2 mixed with the light-scattering particles 170 are successively disposed in the recesses G. Refer to FIG. 6 and FIG. 16 together. Therefore, the light-scattering particles 170 may be fixed in the wavelength conversion layer 130 after the second curable adhesives B2 are cured to form the wavelength conversion layer 130. Incidentally, in one embodiment, the second curable adhesives B2 may also be mixed with the fluorescent particles 150. In this way, after the second curable adhesives B2 are cured to form the wavelength conversion layer 130, the quantum dot particles 140, the fluorescent particles 150, and the light-scattering particles 170 may be fixed together in the wavelength conversion layer 130, as shown in FIG. 6.

To sum up, the wavelength conversion module, the backlight module, and the manufacturing method for the wavelength conversion module in embodiments of the disclosure have at least one of the following advantages. In the wavelength conversion module in the disclosure, the wavelength conversion layers and the quantum dot particles can both convert wavelengths of incident beams. The wavelength conversion layers are not made of a toxic heavy metal. Therefore, the wavelength conversion module in the disclosure can improve wavelength conversion efficiency in the case that a quantity of the quantum dot particles is limited. In addition, the barrier wall structural layer is used to improve the stiffness of the wavelength conversion module in the disclosure, so that the thickness of the wavelength conversion module can be effectively reduced. The above wavelength conversion module is used for the backlight module in the disclosure, so that the thickness can be reduced. In addition, the backlight module can improve color quality even if the quantity of the quantum dot particles is limited. In the manufacturing method for the wavelength conversion module in the disclosure, the barrier wall structural layer is formed by curing the first curable adhesive on the substrate, and then the second curable adhesives are disposed in the recesses in the barrier wall structural layer. Further, the quantum dot particles are mixed into the second curable adhesives, and the wavelength conversion layers can be formed by curing the second curable adhesives. Because the barrier wall structural layer can increase the stiffness of the wavelength conversion layers after the thickness of the wavelength conversion layers is reduced, and the wavelength conversion layers and the quantum dot particles can both provide a wavelength conversion function, the manufacturing method in the disclosure can provide the wavelength conversion module with good wavelength conversion efficiency and a small thickness.

The foregoing description of the preferred embodiment of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure” is not necessary limited the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. A wavelength conversion module, comprising:
a substrate, having a surface;
a barrier wall structural layer, disposed on the surface and defining a plurality of recesses;
a plurality of wavelength conversion layers, wherein each of the wavelength conversion layers is correspondingly disposed in one of the recesses; and
a plurality of quantum dot particles, disposed in the wavelength conversion layers.

2. The wavelength conversion module according to claim 1, further comprising a plurality of fluorescent particles disposed in the wavelength conversion layers.

3. The wavelength conversion module according to claim 1, further comprising a plurality of fluorescent particles disposed in the barrier wall structural layer.

4. The wavelength conversion module according to claim 3, wherein the quantum dot particles are further disposed in the barrier wall structural layer.

5. The wavelength conversion module according to claim 1, further comprising a plurality of light-scattering particles, wherein the light-scattering particles are disposed in the barrier wall structural layer and/or the wavelength conversion layers.

6. The wavelength conversion module according to claim 1, further comprising a cover plate, wherein the wavelength conversion layers are disposed between the substrate and the cover plate.

7. A backlight module, comprising:
a light source, configured to generate an excitation beam; and
a wavelength conversion module, disposed on a transmission path of the excitation beam and comprising:
a substrate, having a surface;
a barrier wall structural layer, disposed on the surface and defining a plurality of recesses;
a plurality of wavelength conversion layers, wherein each of the wavelength conversion layers is correspondingly disposed in one of the recesses; and
a plurality of quantum dot particles, disposed in the wavelength conversion layers.

8. A manufacturing method for a wavelength conversion module, the method comprising steps of:
disposing a first curable adhesive on a substrate and curing the first curable adhesive to form a barrier wall structural layer, wherein the barrier wall structural layer defines a plurality of recesses; and
mixing a plurality of quantum dot particles into a plurality of second curable adhesives, correspondingly filling each of the second curable adhesives in one of the recesses, disposing a cover plate on a side of the barrier wall structural layer facing away from the substrate, and curing the second curable adhesives to form a plurality of wavelength conversion layers.

9. The manufacturing method according to claim 8, wherein before the step of filling the second curable adhesives in the recesses, the manufacturing method further comprises a step of: adding a plurality of fluorescent particles to the second curable adhesives.

10. The manufacturing method according to claim 8, wherein before the step of disposing the first curable adhesive on the substrate, the manufacturing method further comprises a step of: adding a plurality of fluorescent particles to the first curable adhesive.

11. The manufacturing method according to claim 10, wherein before the step of disposing the first curable adhesive on the substrate, the manufacturing method further comprises a step of: adding the quantum dot particles to the first curable adhesive.

12. The manufacturing method according to claim 8, wherein before the step of disposing the first curable adhesive on the substrate, the manufacturing method further comprises a step of: adding a plurality of light-scattering particles to the first curable adhesive.

13. The manufacturing method according to claim 8, wherein before the step of filling the second curable adhesives in the recesses, the manufacturing method further comprises a step of: adding a plurality of light-scattering particles to the second curable adhesives.
